(19) United States
(12) Patent Application Publication
(10) Pub. No.: US 2014/0249882 A1
(43) Pub. Date: Sep. 4, 2014

(54) System and Method of Stochastic Resource-Constrained Project Scheduling

(71) Applicant: The Curators of the University of Missouri, Columbia, MO (US)

(72) Inventor: Haitao Li, St. Louis, MO (US)

(21) Appl. No.: 14/057,776

(22) Filed: Oct. 18, 2013

Related U.S. Application Data
(60) Provisional application No. 61/795,574, filed on Oct. 19, 2012.

(51) Int. Cl. G06Q 10/06

(52) U.S. Cl. CPC G06Q 10/06313
USPC 705/7.23

(57) ABSTRACT

A method or system of optimally scheduling projects with resource constraints and stochastic task durations. This is a new framework in order to solve real world problems of uncertainties and computational dilemma in project scheduling and management. This new framework is devised with a constraint programming (CP) procedure as an approximate dynamic programming (ADP) to reduce the size of domain.

### CROSS-REFERENCE TO RELATED APPLICATIONS

This patent application claims priority to pending U.S. Provisional Patent Application Ser. No. 61/795,574, filed Oct. 19, 2012, and entitled “Stochastic Resource-Constrained Project Scheduling,” the entire disclosure of which is incorporated herein by reference.

### STATEMENT REGARDING FEDERALLY SPONSORED RESEARCH OR DEVELOPMENT

This invention was made with Government support under Grant No. W911NF-10-1-0422 awarded by the U.S. Army Research Office. The Government has certain rights in the invention.

### BACKGROUND OF THE INVENTION

1. Field of the Invention

This invention relates generally to project scheduling and management, more specifically, to scheduling projects with both resource constraints and stochastic task durations.

2. General Background Technology

In the real world project scheduling environment, many uncertainties exist such as task durations or task resources. This type of information is often not known until it is realized. The classical approach to deal with task duration randomness in project management is the well-known PERT analysis (Malcolm et al. (1959), Applications of a technique for research and development program evaluation. Operations Research 7(5): 646-669). However, neither the stream of research on PERT (Slyke, V. and M. Richard (1963), Monte Carlo methods and the PERT problem, Operations Research 11(5): 839-860; Dodin, B. (1984), Determining the K most critical paths in PERT networks, Operations Research 32(4): 859-877; and Reich, D. and L. Lopes (2010), Preprocessing stochastic shortest-path problems with applications to PERT activity networks, INFORMS Journal on Computing to appear) nor its variants of GERT (Taylor, B. W. and L. J. Moore (1980), R&D project planning with Q-GERT network modeling and simulation, Management Science 26(1): 44-59 and Neumann, K. (1999), Scheduling of projects with stochastic evolution structure, Project Scheduling—Recent Models, Algorithms and Applications, J. Weglarz, Boston, Kluwer Academic Publishers: 309-332) explicitly considers resource constraints. That is, they all assume ample resources are available for project execution.

More recent approaches were devised to solve the problem of uncertainties through the stochastic resource-constrained project scheduling problems (SRCPSP). For example, Fernandez, A. A. (1995) (The optimal solution to the resource-constrained project scheduling problem with stochastic task durations, University of Central Florida. Ph.D.) and Fernandez et al. (1998) (Understanding simulation solutions to resource constrained project scheduling problems with stochastic task durations, Engineering Management Journal 10(4): 5-13) devised a stochastic decision model that deals with only activity duration randomness. Their solution approach is similar to the decision-tree method, which is computational intractable even for small size problems. Tsai, Y. M. and D. D. Gemmill (1998) (Using tabu search to schedule activities of stochastic resource-constrained projects, European Journal of Operational Research 111: 129-141) developed a simulation-optimization approach for SRCPSP with activity duration uncertainty. They implemented a tabu search metaheuristic to search the solution space, and use simulation to evaluate each local move. Ballestin, F. and R. Leus (2009) (Resource-constrained project scheduling for timely project completion with stochastic activity durations, Production and Operations Management 18(4): 459-474) combine simulation with a different metaheuristic called greedy randomized adaptive search procedures (GRASP) to obtain high quality solutions to SRCPSP.

The present invention is directed to overcoming one or more of the problems set forth above.

### SUMMARY OF THE INVENTION

In one aspect of the invention, a system for optimally scheduling a plurality of activities is disclosed. The system includes a memory configured to store data, where the data represents a plurality of activities and the plurality of activities are uncompleted, uncertain activities, an input device for providing the data into the memory, a processor configured to find a subset of the plurality of uncompleted, uncertain activities, as a first stage, that are eligible to be started at the first stage, where the eligibility is determined based on one or more eligibility requirements, then generate, for each of the eligible activities found, all feasible sequences of activities that can be executed in a predetermined order following the each of the eligible activity, where the feasible sequences of activities satisfy the eligibility requirements and a set of pre-defined constraints, then calculate, for each of the generated feasible sequences, a cost-to-go function, where the processor calculates an expected total cost for executing the activities in each of the generated feasible sequences, then select an optimal activity among the eligible activities, where the optimal activity is an activity which generates the sequence of activities with the lowest cost-to-go-function, then assign the optimal activity as a completed-activity when the optimal activity is completed, where the completion of the optimal activity triggers a second stage, where the second stage involves repeating the first stage, with the processor, until all the activities in the plurality of activities are assigned as the completed activity, and an electronic display for viewing the scheduling of activities, where the memory, the input device and the electronic display are all electrically connected to the processor.

In another aspect of the invention, a system for optimally scheduling a plurality of activities is disclosed. The system includes a memory configured to store data, where the data represents a plurality of activities and the activities are uncompleted, uncertain activities, an input device for providing the data into the memory, a processor configured to find a subset of the uncompleted, uncertain activities, as a test stage, that are eligible to be started at a first stage, where the eligibility is determined based on one or more eligibility requirements, then generate, for each of the eligible activities found, N samples of feasible sequences of activities that can be executed in a certain order for each of the eligible activity, where the feasible sequences of activities satisfy the eligibility requirements and a set of pre-defined constraints, then calculate a mean value of cost-to-go functions of any of these same the feasible sequences of activities that are randomly generated, where the cost-to-go function is an expected total cost for executing the activities in the generated feasible sequence, then store the mean value in the memory during the test stage, then, at a first stage, find a subset of the uncompleted, uncertain activities that are eligible to be started at the first stage, where the eligibility is determined based on one or more of eligibility requirements, then generate, for each of the eligible activities found, N samples of feasible sequences of activities that can be executed in a certain order following each of the eligible activity, where the feasible sequences of activities satisfy the eligibility requirements and the set of pre-defined constraints, then calculate a cost-to-go function of only those feasible sequences of activities whose mean values are not calculated during the test stage, then the processor retrieves from the memory the stored mean value of the feasible sequence generated during the test stage and utilizes the retrieved mean value as a cost-to-go function of any feasible sequence generated during the first stage that is identical to the feasible sequence generated during the test stage, the processor then selects an optimal activity among the eligible activities, where the optimal activity is an activity which generates the sequence of activities with the lowest cost-to-go-function, the processor then assigns the optimal activity as a completed-activity when the optimal activity is completed, where the completion of the optimal activity triggers a second stage, where at the second stage, repeat the first stage, where the processor repeats the first stage until all the activities in the pool are assigned as a completed activity, and an electronic display for viewing and scheduling of all activities, where the memory, the input device and the electronic display are all electrically connected to the processor.

In still another aspect of the invention, a system for optimally scheduling a plurality of activities is disclosed. The system includes a memory configured to store data, where the data represents a pool of activities the activities are uncompleted, uncertain activities, a processor configured to find a subset of the uncompleted, uncertain activities, as a first stage, that are eligible to be started at the first stage, where the eligibility is determined based on one or more of eligibility requirements, then generate, for each of the eligible activities found, all feasible sequences of activities that can be executed in a predetermined order following the each of the eligible activity, where the feasible sequences of activities satisfy the eligibility requirements and a set of pre-defined constraints, then calculate, for each of the generated feasible sequences, a cost-to-go function, where the processor calculates an expected total cost for executing the activities in each of the generated feasible sequences, then select an optimal activity among the eligible activities, where the optimal activity is an activity which generates the sequence of activities with the lowest cost-to-go-function, then assign the optimal activity as a completed-activity when the optimal activity is completed, where the completion of the optimal activity triggers a second stage, where the second stage involves repeating the first stage, with the processor, until all the activities in the pool are assigned as a completed-activity, and a user interface unit configured to provide a user the optimal sequence of activities, where the user can retrieve data representing the optimal sequence of activities from the memory and for inputting data into the memory.

Yet another aspect of the present invention is a method for optimally scheduling a plurality of activities is disclosed. The method includes storing data provided by an input/output device representing a pool of activities in a memory, where the activities are uncompleted, uncertain activities, finding a subset of the uncompleted, uncertain activities that are eligible to be started at a first stage, where the eligibility is determined based on one or more of eligibility requirements with a processor from the memory, generating, with the processor, for each of the eligible activities found, all feasible sequences of activities that can be executed in a certain order following the each of the eligible activity, where the feasible sequences of activities satisfy the eligibility requirements and a set of pre-defined constraints, where each of the generated feasible sequences is stored in the memory, calculating, with the processor, for each of the feasible sequences of activities generated, a cost-to-go-function which represents an expected total cost for executing the activities in each of the generated sequences, where each of the calculated cost-to-go-function is stored in the memory, selecting an optimal activity among the eligible activities, with the processor, where the optimal activity is an activity which generates the sequence of activities with the lowest cost-to-go function, assigning the optimal activity as a completed-activity when the optimal activity is completed, where the completion of the optimal activity triggers a second stage with the processor, and repeating, at the second stage, the steps of the first stage, where the processor repeats the first stage until all the activities in the pool are assigned as a completed activity and providing all the completed activities on the input/output device.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF THE DRAWINGS

For a better understanding of the present invention, reference may be made to the accompanying drawings in which:

FIG. 1 depicts an example of a classification of randomness/uncertainty in project networks;

FIG. 2 is a schematic block diagram of an exemplary system for an exemplary embodiment of the integrated constraint programming and approximate dynamic programming or CP-ADP framework;

FIG. 3 depicts a process flow of operating an exemplary embodiment of the CP-ADP framework;

FIG. 4 depicts a project scheduling problem as a sequential decision process;

FIG. 5 depicts a proposed CP-ADP framework to solve the Markov decision process (MDP) model of SRCPSP;

FIG. 6 depicts a flowchart of an exemplary embodiment of the CP-ADP framework;

FIG. 7 depicts an exemplary code for the CP-ADP algorithm for deterministic RCPSP;

FIG. 8 shows the results of the CP-ADP performance on deterministic instances;

FIG. 9 shows an impact of different configurations of limited simulation on solution quality;

FIG. 10 shows an impact of different configurations of adjusted R-square of linear regression on solution quality;

FIG. 11 shows the results of the CP-ADP performance on small stochastic instances;

FIG. 12 shows the results of the CP-ADP performance on large stochastic instances;

FIG. 13 shows a lookup table obtained by a training phase of the ADP-HBA algorithm, where HBA stands for hybrid look-back and look-ahead; and

FIG. 14 shows the results of the ADP-HBA performance.

Reference characters in the written specification indicate corresponding items shown throughout the drawing figures.

### DETAILED DESCRIPTION OF THE INVENTION

In the following detailed description, numerous exemplary specific details are set forth in order to provide a thorough understanding of the invention. However, it will be understood by those skilled in the art that the present invention may be practiced without these specific details, or with various modifications of the details. In other instances, well know methods, procedures, and components have not been described in detail so as not to obscure the present invention.

Many real world project scheduling decisions are subject to limited resources: budgets, machines, equipment, manpower, raw materials, etc. Such optimization problems are known as the resource-constrained project scheduling problem (“RCPSP”). The RCPSP can be applied to various fields of industry, for example, in the area of machine scheduling, supply chain design and optimization, workforce optimization, and optimization of the onboard scheduling and manning decisions for a military ship.

One of the representative RCPSP methods is a deterministic model, which assumes that the problem parameters are constant and does not explicitly consider uncertainty. A deterministic model assumes that the problem parameters are constant and does not explicitly consider uncertainty. In practice, it is solved using some point estimates of problem parameters. A drawback of such an approach is that the solution recommended by a deterministic model may not be optimal or even feasible after realization of random parameters.

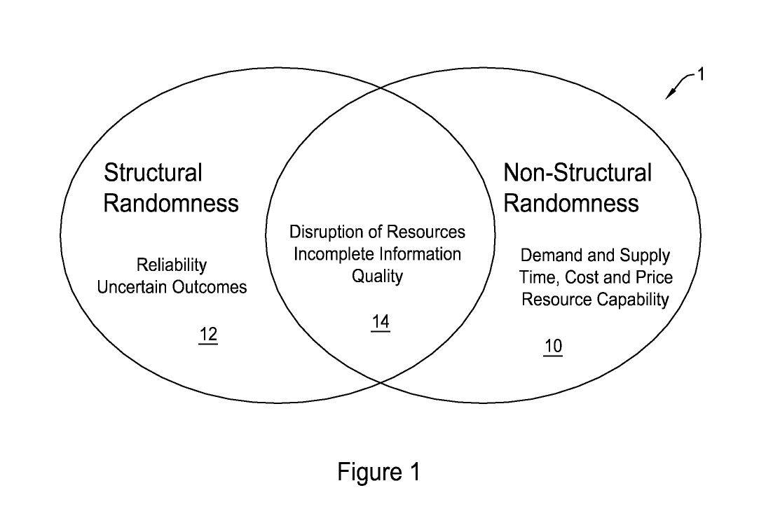

The potential uncertainty and randomness involved in project scheduling can be generally classified into two categories, based on whether it changes the structure of a network or not. That is, the structural randomness which potentially changes the network structure, and the non-structural randomness which changes only problem parameters without altering the network structure. FIG. 1 depicts such a classification scheme generally by numeral 1. The non-structural randomness may be caused by uncertainty about demand/supply, task duration (lead time), cost/price, quality, or resource capacity as indicated by numeral 10. Two causes for structural randomness include reliability (success/failure) and uncertain outcomes of a task as indicated by numeral 12. Some other uncertainty may or may not be structural, such as disruption of resources, incomplete information, or quality as indicated by numeral 14.

In the manufacturing environment, task durations may be uncertain, resources/supply capacity may vary or even be disrupted due to maintenance or unexpected incidence, production quality may also vary. When considering bidding decisions, the parameters describing competitor's bidding behavior in a decision-theoretic model may be uncertain due to incomplete information.

In the more general study supply chain setting, sourcing and scheduling decisions may be significantly impacted by uncertainty about lead time, direct cost added (e.g., varying transportation cost due to volatile fuel prices in recent years), capacity of supply, market demand, etc.

When optimizing project portfolios for service enterprises, the decision maker must consider the uncertainty about workforce capacity due to workforce commitment rate, offshore risks, and attrition. Other uncertainty involves success rate of bidding, as well as project/task durations. In many research and development (“R&D”) projects, the outcome of a task may be uncertain, e.g., high success, moderate success, or failure, and their probabilities may be correlated, giving rise to the GERT-type structural randomness in project scheduling. To deal with various certainty and randomness in many real-life project scheduling applications calls for research on RCPSP under uncertainty, giving rise to the RCPSP with stochastic task durations.

Project scheduling under both uncertainty and resource constraints is studied under an emerging research subject known as the stochastic resource-constrained project scheduling problem (SRCPSP). Comparing with the vast research literature of solution methods on the deterministic RCPSP, research on computational algorithms for SRCPSP is sparse. For example, an early solution approach for SRCPSP was based on the idea of scheduling policies. A policy can be viewed as an on-line decision process that determines which activities are to be started at a decision point. A well-known type of scheduling policy is the class of priority based policies, in which all activities are ranked according to certain priority list, and started in the order specified by the list. Although easy to implement, this policy based approach has several drawbacks: (1) there exist some problem instances for which no priority policy yields optimal schedule and (2) they may suffer the Graham anomalies. Other known methodologies involve modeling a stochastic decision problem with activity duration randomness; however, these works were faced with a dilemma that developing a framework sophisticated enough to consider real-world problems of uncertainties would necessarily create more burden on a computational power of a framework thus resulting in an intractable system.

### I. The CP-ADP Framework

The present invention provides a novel approach for solving the challenges presented above by developing a new framework that adopts new models and computational algorithms. The basic RCPSP modeling is constructed as a sequential decision problem which provides a vehicle for modeling the RCPSP with complex uncertainty and randomness as a Markov Decision Process (MDP). In addition, in order to overcome the challenge arising from the computational side (i.e., the curses-of-dimensionality), the new framework is devised with an approximate dynamic programming (ADP) algorithm in a rollout framework to reduce the size of domain. Preferably, the new framework adopts a constraint programming (CP) procedure as an ADP to heuristically estimate an approximate cost of performing a given set of activities. CP's declarative nature can significantly reduce the model size compared with the pure integer programming formulation. Furthermore, many well-developed constraint propagation algorithms are quite efficient for binary constraints ubiquitous in scheduling problems. In addition, integrating CP with other optimization methods can often reduce the burden for CP alone to search the solution space. For purposes of clarity, this new framework will be referred to herein as “CP-ADP.” The proposed CP-ADP framework can be applied to a variety of different fields such as construction industry, IT and professional service industry, research and development, Make-to-Order (MTO) manufacturing, military mission and campaign planning, etc.

### A. Overview of the System Architecture of the CP-ADP Framework

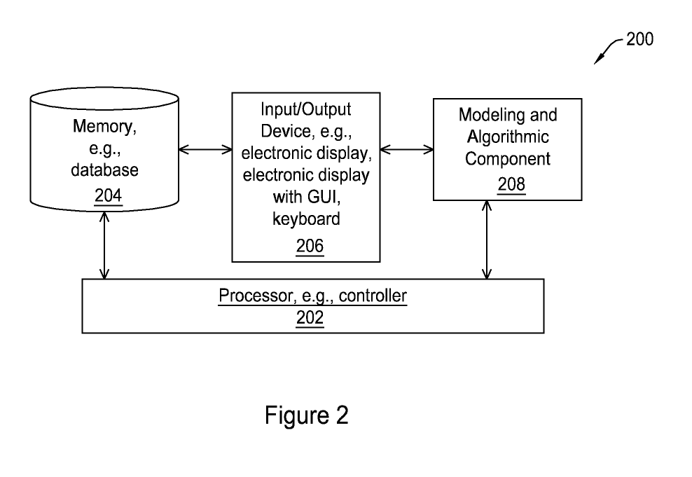

FIG. 2 is a schematic block diagram of an exemplary system 200 for an exemplary embodiment of the CP-ADP framework. The exemplary system 200 of FIG. 2 may include a processor 202, where the processor 202 can include any type of computer, controller, or other type of computing mechanism. Moreover, the processor 202 may include one or more processors, computer-readable media, and other computing components or devices. The processor 202 is electrically connected to a memory 204, which preferably functions as a database of inputted data. There is an input/output device 206 that is preferably an electronic display with interactive screen, however, any other type of separate input device and separate output device may also suffice including, but not limited to a keyboard, electronic display, and so forth. Preferably there a modeling and algorithmic component 208 that is in electronic communication with the processor 202 and the input/output device 206. The system 200 can preferably be implemented as one or more computing devices. The system 200 can be any computing device with sufficient computational and network-connectivity capabilities to interface with other components of the system 200 for the purposes described herein. For example, the system 200 can be a server, personal computer, a mobile device, or tablet computer. It should be understood that different configured computing devices can be employed as the system 200.

The processor 202 controls data flow between and provide basic hardware structures for the memory 204, the input/output device 206, and the modeling/algorithmic component 208. The memory 204 stores project data needed for the modeling of the CP-ADP framework. The data can include the work-breakdown structure (“WBS”) of the project characterized by precedence relationships among activities, resource requirements of activities, available resource capacities, and probability distribution of activity durations. The memory 204 also dynamically updates the current state of the project by keeping a record of activities that are completed, activities that are in progress, and currently available resource capabilities. The processor 202 controls data communications between each component of the system 200, for example, data communications between the memory 204 and the input/output device 206 and data communications between the memory 204 and the modeling/algorithmic component 208.

The input/output device 206 provides an interface between a user and the system 200. The user may input new project data to the memory 204 or retrieve any data from the memory 204. For example, the user may add a new resource requirement or update the memory 204 with newly available resources to the system 200. The user can also change or modify any pre-stored data in the memory 204 using the input/output component 206. The input/output component 206 preferably includes a display device which provides a graphical user interface (GUI) to the user. The user can view the algorithm settings and visualization of the current state of a project. For example, the input/output component 206 may visualize the optimized project schedules as a Gant Chart, with horizontal bars representing project activities and resource profile showing utilization of resources. However, it should be understood that any form of interface can be implemented in the input/output device 206.

The modeling/algorithmic component 208 generates the model to be solved by the CP-ADP algorithm, based on the information retrieved from the memory 204. The CP-ADP framework can be applied to either the deterministic RCPSP or SRCPSP. Preferably, the component adopts the Markov decision model to generate either the deterministic RCPSP or SRCPSP as described herein. Alternatively, any workable modeling method can be implemented for the CP-ADP framework, if the modeling method suits with the concepts of the ADP and CP as illustrated below. Once the basic model is constructed by the modeling and algorithmic component 208, the modeling and algorithmic component 208 executes a computer program code stored in the memory 204 that implements the CP-ADP algorithm. The code can be written in any programming language, e.g., C/C++, C#, Java, etc., that suits best for the memory 204 and the input/output device 206 in the system 200. Alternatively, the code can be stored internally in the component. The component 208 further compiles algorithm code into executable and executes the CP-ADP algorithm. The optimized project schedule solution is then sent back to the input/output device 206 for user to view and implement.

In an alternative embodiment, the system 200 can be configured in a distributed system. For example, the memory 204 can be remotely placed in a different system, which can be accessible via a network by the system 200 or the user. In addition, other components (input/output device 206 and modeling and algorithmic component 208) can reside on a different system or network. In this embodiment, the processor 202 or the system 200 communicates with components that are remotely placed to activate the system. For example, if the modeling/algorithmic component 208 is residing in a remote computer, the processor 202 contacts the modeling and algorithmic component 208 and grants an access for the modeling and algorithmic component 208 to retrieve data from the memory 204 in order to generate the model and run the CP-ADP algorithm. In this embodiment, the user can also utilize a remote device to connect to the system 200 and retrieve data from the memory 204 for review and visualization of the scheduling result.

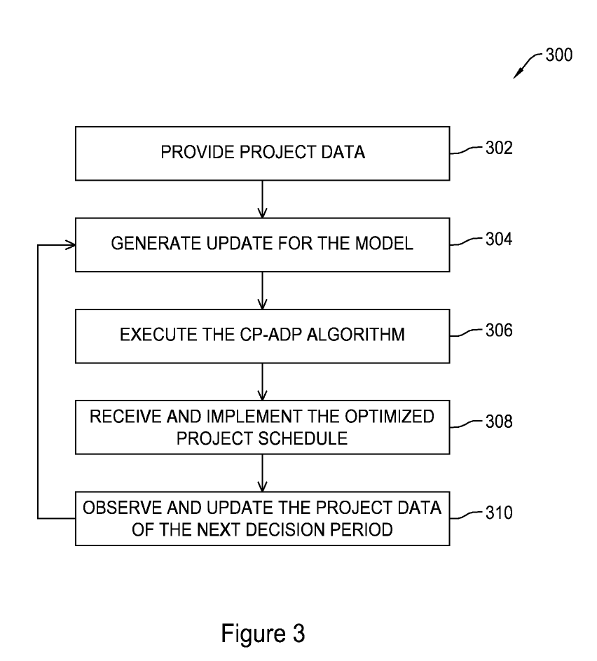

FIG. 3 illustrates a flow chart of an exemplary embodiment of the invention that implements the CP-ADP algorithm that is generally indicated by numeral 300. At step 302, the user prepares data of a project to be optimized. This data includes a pool of activities that need to be executed in a certain order to accomplish a common goal. The data also includes precedence relationships among activities, resource requirements of activities, available resource capacities, and probability distribution of activity durations. Alternatively, such data can be provided by a third party or automatically and/or randomly generated by the processor 202 without the user involvement.

At step 304, the modeling and algorithmic component 208 generates a model. In case of the deterministic RCPSP, the modeling and algorithmic component 208 generates the RCPSP model as illustrated below in Section II-A. In case of the SRCPSP, the modeling and algorithmic component 208 generates the SRCPSP model as illustrated below in Section II-B. Preferably, this modeling is performed by a Markov decision process but any other applicable modeling methods could be used.

At step 306, the CP-ADP algorithm is executed by the component 208 to solve the given model at step 304. In the preferred embodiment, the CP-ADP algorithm can be configured to suit for either the deterministic RCPSP or SRCPSP; however, any type or any variation thereof can be employed as illustrated below. An optimized scheduled is obtained by the algorithm.

At step 308, the optimized schedule is retrieved to the user via the input/output device 206. The user can therefore implement the activities as set forth by the optimized schedule.

At step 310, the user observes and updates the project data (state) of the next decision period. The next iteration starts by updating the model based on the updated state of the project and follows the same steps from 306 to 310. Preferably, the next state enters only if at least one activity is completed in a previous state. The decision process terminates when all project activities stored have been completed.

In an alternative embodiment, the system 200 of FIG. 2 is configured to provide a user interface which allows a user to choose between the RCPSP and SRCPSP. For example, at step 304, the user is asked whether he or she wants to generate a model for RCPSP or SRCPSP. This can be done through a pop-up message window or other user friendly interfaces such as a check-in box and drop-down menu. Likewise, at step 306, the user can be asked which algorithm he or she wants to use for the generated model of either RCPSP or SRCPSP.

### B. Approximate Dynamic Programming

Dynamic programming (DP) is a powerful methodology in Operations Research (OR) for modeling and solving sequential decision problems (either deterministic or stochastic), where the decision is sequentially made to optimize the overall value function. However, it is well-known that solving the recursive optimality Bellman equations is practically intractable when the state or decision variable is multi-dimensional. Various computational strategies, under the umbrella of stochastic approximation methods, have been developed to resolve the “curse of dimensionality,” e.g., rolling-horizon procedures, stochastic search, and simulation-based optimization. Among them, one attractive computational paradigm is approximate dynamic programming (ADP). The essence of ADP is to replace the true value function (e.g., cost-to-go function) in DP with some form of approximation. The purpose of this approximation is to avoid complicated computation involved in exactly solving the original optimization problem. Instead of working backwards as in the backward recursion in the classical DP, ADP steps forward in time following a particular sample path, which refers to a particular sequence of exogenous information. The forward iteration procedure utilizes some sampling techniques such as Monte Carlo simulation to obtain random samples of information. Such a forward iteration scheme eliminates the need for exhaustively visiting all possible combinations of state.

### C. Constraint Programming

Constraint programming is generally defined as the studies of computational systems with constraints. The main solving techniques of CP include constraint propagation and search. Constraint propagation, also known as domain reduction, reduces the domain of all variables in a constraint, given the modification of one variable in that constraint. However, although the domain of each variable in an optimization problem can be reduced through constraint propagation, reducing a problem to the problem for which no more redundant values can be removed from the domain is often NP-hard. Thus, a search procedure is often needed to explore the reduced solution space.

One advantage of CP is its declarative nature that makes an optimization model expressive and compact with fewer decision variables and constraints, compared with the traditional MILP formulation. Such reduction of model size is even more significant for modeling scheduling problems. In contrast, the modeling power of an MILP has been greatly hampered by the disjunctive (big-M) formulation required for scheduling modeling. However, a CP algorithm alone solves an optimization problem through a naïve branch-and-bound method by gradually tightening a bound on the objective function. For a minimization problem with an objective function f(x), for instance, when a feasible solution x′ is found, a constraint f(x)<f(x′) is added to the constraint store of each subproblem in the remaining search tree.

### D. Markov Decision Process Model for the CP-ADP Framework

ADP provides a unified framework for tackling high dimensional sequential decision problems. The use of post-decision variables makes it possible to solve real-life high-dimensional Markov Decision Process (MDP) models with arbitrarily complex exogenous randomness. This is achieved by separating the random effects from a deterministic version of the decision problem at each ADP iteration. A generic modeling method of the CP-ADP by using a MDP will be discussed herein.

### Definition of Decision Stages

A decision stage of the CP-ADP model is defined as a time point when any task is scheduled to be completed. There are at most [V] decision stages, where V denotes the set of all project tasks.

### Definition of States

The state at stage i is define as Sᵢ={Cᵢ, Aᵢ, Eᵢ, Rₖᵢ}, where Cᵢ denotes the set of completed activities, Aᵢ is the set of active activities in progress, Eᵢ represents the set of eligible sets of activities, satisfying both precedence and resource constraints, that can be started at stage i, and Rₖᵢ denotes the availability of resource k at stage i.

### Definition of Decisions

The decision made at each stage is a set of activities to be started at that stage. Let the decision at stage i be XᵢεEᵢ, i.e., one element among all eligible sets. Eᵢ must be described using the other state variables as follows:

{Eᵢ|∀eεEᵢ satisfies all precedence constraints and Σ_{jεeUAi}rⱼₖ≦Rₖᵢ}, (1)

where rⱼₖ is the requirement of resource k by activity j.

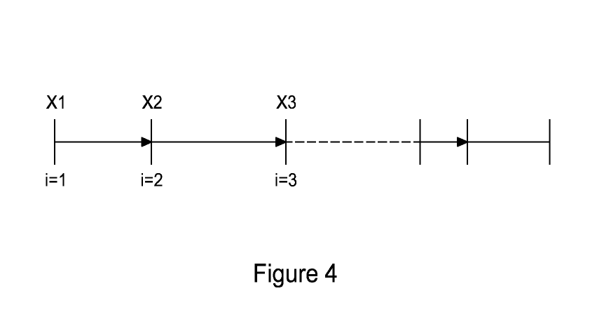

FIG. 4 depicts a project scheduling problem as a sequential decision process. At each decision stage i, a set Xᵢ of activities is scheduled to be started. The system reaches the next stage i+1 when any activity is completed. Then decision Xᵢ₊₁ at stage i+1 is made. The process continues until all activities have been scheduled.

### Transition Process

The transition process of the stochastic dynamic programming problem can be described as follows:

Sᵢ₊₁=S^{M}(Sᵢ,xᵢ,wᵢ), (2)

where Sᵢ₊₁ represents the state at stage i+1, which depends on the state Sᵢ, decisions xᵢ, and random disturbance wᵢ. This transition process model is general enough to capture both non-structural and structural randomness. The random disturbance wᵢ may include non-structural randomness such as uncertain durations, uncertain resource requirements and capacities, as well as structural randomness such as uncertain task outcomes, task success/failure rates, etc. It is assumed that wᵢ has a given probability distribution that depends only on the current state and decision, which is known as the Markov property. In more general situations, wᵢ may also include exogenous information arriving between stage i and i+1. S^{M}(·) denotes the state transition function and could represent a probability transition matrix as in GERT networks.

### Cost-To-Go Function

In the model, gᵢ(S, x, w) denotes the one-stage cost function. When the objective is to minimize makespan, for instance, gᵢ(S, x, w) represents the increment of makespan at stage i. The task is to choose the best policy (or decision rule) π among the set of policies Π to minimize the expected total cost over a finite number of stages i={0,1, . . . , |V|}. The cost-to-go function of π starting from a state-time pair (Sᵢ, i) can be written as:

Jᵢ(Sᵢ)={Σⱼ₌ᵢ^{|V|}gᵢ(Sᵢ,xᵢ^{π},wᵢ)} (3)

The cost-to-go function can be calculated through the following DP recursion (Bellman [27]):

Jᵢ(S)= [symbol] {g(S,xᵢ^{π},w)+Jᵢ₊₁(S^{M}(S,xᵢ^{π},w))} (4)

For the MDP model of the CP-ADP framework, it is not difficult to see that the classical DP suffers the well-known “curses of dimensionality”: (1) The number of states is combinatorial in nature, thus it is infeasible to enumerate all possible combinations of problem parameters. (2) The decision variable xᵢ involves an NP-hard combinatorial optimization (scheduling) problem, for which a complete enumeration of solution values is prohibitive.

### E. Rollout Algorithm

The key idea of rollout algorithm is to replace the true cost-to-go function by some form of function approximation. The optimal cost-to-go Jᵢ₊₁(·) in (4) above is replaced with some approximation L̅_{+1(·)}, which can be obtained by some base policy (heuristic). Then the decision associated with each stage made by the rollout policy is obtained by:

x̅ᵢ(S)=arg min_{xεE(s)}(s) [symbol] {g(S,x,w)+ J̅ᵢ₊₁(S^{M}(S,xᵢ^{π},w))} (5)

The rollout framework is especially attractive for combinatorial optimization problems, for which either problem specific heuristics, local search or metaheuristic methods are available to serve as the base policy.

### F. The CP-ADP Algorithm

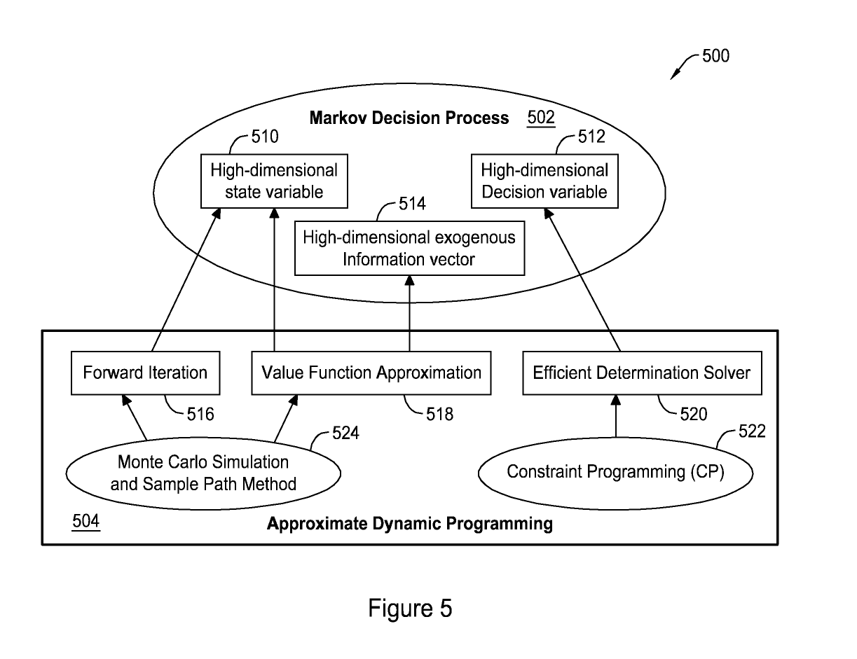

The proposed CP-ADP framework can be sketched by FIG. 5 and generally indicated by numeral 500. Three types of computational challenge are identified for the MDP model 502 at the top, i.e. the high-dimensional state variable 510, high-dimensional decision variable 512 and high-dimensional exogenous information vector 514. Three main techniques, i.e. forward iteration 516, value function approximation 518, and deterministic solver 520 employed in an ADP algorithm 504, are listed. The integration of CP 522 into ADP 504 as the solver for deterministic RCPSP or SRCPSP sub-problem is highlighted at the bottom of the diagram. Details of the three techniques will be elaborated next.

### Forward Iteration

Instead of working backward through time (as in the classical DP), ADP steps forward in time following a particular sample path wεΩ, which refers to a particular sequence of exogenous information. The forward iteration procedure utilizes some sampling technique such as Monte Carlo simulation to obtain random samples of information. Using the random sample of disturbance Wₜ₊ᵢ generated at t, the algorithm is able to determine the state Sₜ₊₁ of t+1 using the transition function in (2) of Section I-D. The forward iteration scheme eliminates the needs of exhaustively visiting all possible combinations of states.

### Value Function Approximation

The essence of ADP is to replace the true cost-to-go function Jᵢ(Sᵢ) with some form of approximation J̅ᵢ(Sᵢ). The purpose of such approximation is to avoid complicated computation involved in exactly solving the original optimization problem. Several approximation architectures are possible for the MDP:

(1) Monte Carlo simulation 524. The use of Monte Carlo simulation for approximating the cost-to-go function was suggested in the context of a backgammon game. This approach generates a large number of simulated trajectories of the system for all possible decisions at the current stage. The costs of these trajectories are averaged to compute an approximation of the cost-to-go function value. Then the best decision is one that has the minimum (approximate) cost-to-go function value.

(2) Sample path method using certainty equivalence. The key idea is to generate multiple scenarios about random problem parameters. Then the cost-to-go function value can be approximated as certain function of objective value associated with each scenario. A promising functional form is the linear combination of each scenario's objective value, where the weights in the linear function can be trained through neural network techniques or temporal difference (TD) learning.

### Deterministic Solver

Due to the combinatorial nature of RCPSP, traditional LP and MILP methods often fail to obtain high-quality solutions efficiently. The solution method based on priority-based dispatching rules suffers the so-called Graham's anomalies. At the core of the ADP algorithm will be the use of CP to model and solve the scheduling sub-problem in each iteration.

### II. Exemplary Embodiments of the CP-ADP Framework

In the present invention, the proposed CP-ADP framework has been implemented for both deterministic RCPSP and SRCPSP models. However, it should be understood that the CP-ADP framework can be implemented for other models and other purposes as it will be appreciated by ordinary skill in the art. For example, the CP-ADP framework can be combined with a traditional look-back approach as illustrated below as an alternative embodiment.

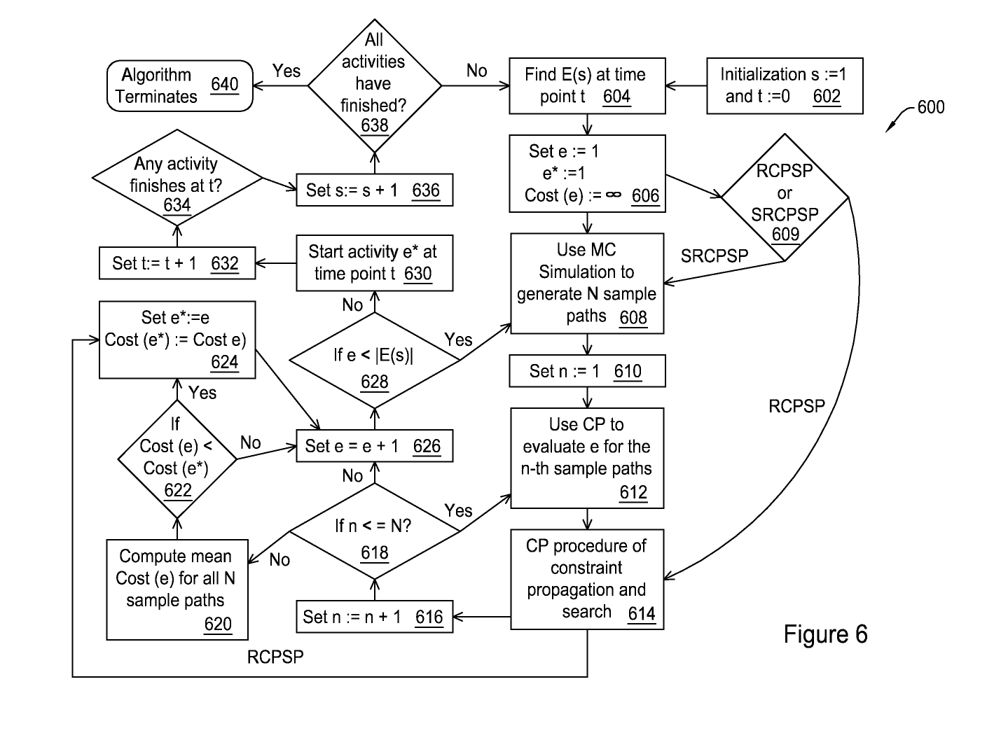

FIG. 6 illustrates a flow chart of an exemplary embodiment of the CP-ADP framework by numeral 600. This embodiment shows how the CP-ADP framework can be applied to both areas of deterministic RCPSP and SRCPSP.

At step 602, the algorithm initiates a time and stage counter: s=1 and t=0. A set of E(s) of activities eligible to start at the current time/stage are identified at step 604. An activity is eligible as long as its start does not violate either the time constraint or the resource constraint. The activity e and the best activity e* is set to 1 and the best cost (e*) is set to ∞ in step 606.

At step 609, the system makes a decision whether or not the given model is for RCPSP or SRCPSP. If the given problem model is SRCPSP, the system enters step 608. A method of Monte Carlo simulation is used to generate N sample paths at step 608. The variable n for paths is set to one in step 610. For each path n, CP is used to solve the resulting scheduling sub-problem at step 612. CP, including various constraint propagation methods and search procedures effectively and efficiently handles each deterministic sub-problem at step 614.

Alternatively, other CP methods can be used to evaluate each sub-problem. After the N MC samples are evaluated for activity e by incrementing each path n by one in step 616 and testing in step 618, the algorithm computes the mean (average) cost of starting e at step 620. If the mean cost of e is less than the currently lowest mean cost at step 622, then the algorithm updates the lowest mean cost and the best candidate activity e* to start at step 624. This procedure exists step 628 after all the activities in E(s) have been evaluated by incrementing the activities e in step 626.

If the given model is RCPSP, the system skips MC simulation (step 608) and moves directly to step 614. The system generates all feasible sequences of activities for the chosen e based on a given priority rule. Preferably, the priority rule can be either static or dynamic. However, same CP procedure of constraint propagation and search being used for SRCPSP or even other CP methods can be used for RCPSP model as an evaluation method. Next, at step 624, once the algorithm evaluates the cost-to-go functions of all feasible sequences satisfying the rule, e with the lowest cost is selected as the best activity. This procedure is repeated, at step 628, until all candidates of e are evaluated. The remaining procedures will be identical as the SRCPSP model.

Next, the best activity e* is started at the current time t at step 630. The time counter t is incremented by 1 at step 632. If there is one task that finishes at t at step 634, the state counter s is incremented by 1 at step 636. If all the activities have finished at step 638, then the whole procedure terminates at step 640.

In an alternative embodiment, at step 609, a user is allowed to choose between RCPSP and SRCPSP.

### A. The CP-ADP Framework for Deterministic RCPSP

The basic model for the CD-ADP framework is described in Section I above. This section will describe an exemplary embodiment of the CP-ADP framework for deterministic RCPSP.

The dynamic programming (DP) formulation of deterministic RCPSP can be stated as follows. A partial schedule at stage i−1 is given by (X₁, X₂, . . . , Xᵢ₋₁). We let L(X₁, X₂, . . . , Xᵢ₋₁) denote the project makespan associated with the partial schedule at i−1. Then the decision to be made at stage i is to minimize L(Xₗ, X₂, . . . , Xᵢ₋₁, Xᵢ), subject to both temporal and resource constraints. Let L*(X₁, X₂, . . . , Xᵢ₋₁, Xᵢ) denote the optimal makespan starting from the solution (X₁, X₂, . . . , Xᵢ₋₁, Xᵢ). If the optimal cost-to-go function L*(X₁, X₂, . . . , Xᵢ₋₁, Xᵢ) is known, the system could obtain optimal solution by a sequence (|V| at most) of minimization problems. In particular, an optimal schedule (Xᵢ*, . . . , X_{|V|*) can be obtained through the Bellman recursion:}

Xᵢ*=arg minₓ_{ᵢ}_{εE}_{ᵢ}L*(Xᵢ*, . . . , Xᵢ₋₁*,Xᵢ), ∀i=1, . . . |V| (6)

Unfortunately, the recursive algorithm in (6) is practically infeasible as it suffers the well-known “curse of dimensionality”. Specifically, there are numerous possible states and alternative feasible schedules, which makes it very difficult to obtain the exact form of L*.

The CP-ADP algorithm is based on the fundamental idea of neuro-dynamic programming, which replaces L* with its approximation L̅, and successively obtaining suboptimal solutions ( X̅₁, . . . X̅_{|V|}) by solving:

X̅ᵢ=arg minₓ_{ₓ}_{εE}_{ᵢ} L̅( X̅₁, . . . , X̅ᵢ₋₁, X̅ᵢ) ∀i=1, . . . , |V| (7)

The function L̅ is called the approximate cost-to-go function. For combinatorial optimization problems, L̅ can be obtained by problem-specific heuristics in the so-called rollout algorithm framework. In the rollout algorithm, CP is used to obtain the approximate cost-to-go function L̅. On one hand, the rollout procedure provides one way to decompose the RCPSP into smaller subproblems that are easier to handle; on the other hand, CP offers an effective methodology to model and solve the scheduling subproblem in each iteration.

### The Priority-Based Rule Heuristic

The priority-rule based heuristic is readily available to serve as the base policy in the rollout framework for RCPSP. The serial generation scheme (SGS) constructs a feasible schedule by extending a partial schedule iteratively. In each iteration, SGS selects one or multiple activities, from the set of eligible activities, to start, according to certain priority rule.

Let RH^{h} denote the rollout algorithm based on the priority-rule heuristic H^{h} with scoring function h(·). RH^{h} for the deterministic RCPSP can be summarized as:

x̅ᵢ(S)=arg minₓ_{ᵢ}_{εE}_{ᵢ₍ₛ₎}H^{h}(x) (8)

At each stage, H^{h} is used to evaluate each candidate activity in the eligible set. The one(s) resulting in minimum makespan is selected to start.

Sequential consistency is defined in the context of RCPSP.

DEFINITION 1. A heuristic is sequential consistent if whenever it generates an activity sequence (j,jᵢ, . . . , n+1) starting at j, it also generates the sequence (jᵢ, . . . , n+1) starting at activity j₁.

Letting the priority value of activity j be given by a scoring function h(j), a static priority rule is defined below.

DEFINITION 2. A priority rule is static if h(j) does not change during the SGS.
LEMMA 1. The SGS with a static priority rule is sequential consistent.
PROOF. Assume that if SGS generates a feasible sequence (j, j₁, . . . , jₙ₊₁) starting at j, it does not generate the sequence (j₁, . . . , jₙ₊₁) starting at activity j₁. Since the priority values of all activities remain the same, this can only happen when the sequence (j₁, . . . , jₙ₊₁) is time- or resource-infeasible, a contradiction.

RH^{h} has the following property.

PROPOSITION 1. RH^{h} always improves over a one-pass execution of the static priority-rule heuristic H^{h} for deterministic RCPSP.
PROOF. Let (j₁, j₂, . . . , jᵢ, . . . ) be the sequence of activities generated by RH^{h} starting from activity j₁. For each i=1, 2, . . . , n+1, let (ji, jᵢ_{⁺¹}′,j_{i′}_{⁺²}′, . . . , jₙ₊₁) be the sequence generated by the priority-rule based heuristic 2-C^{h} starting from activity jᵢ. Lemma 1 implies that RH^{h} and H^{h} generate the same sequence (0,jᵢ, . . . jᵢ) up to jᵢ i.e.,

H^{h}(jᵢ)=H^{h}(Jᵢ_{⁺¹}′), (9)

when a better sequence might be found by evaluating the alternative activities in the eligible set through (6):

H^{h}(jᵢ₊₁)=min_{xεE(s)}H^{h}(x)≦g−fh(jᵢ_{⁺¹}′) (10)

Combining (9) and (10), the below is obtained:

H^{h}(ji+i)≦−H^{h}(ji), (11)

which holds for i=1, 2, . . . , n−1. Therefore, the quality of solutions obtained by RH^{h} is no worse than that obtained by a one-pass execution of H^{h}.

REMARK 1. If the priority rule h(·) is dynamic, i.e. the score of an activity may change during list scheduling, H^{h} may not be sequential consistent. Proposition 1 may still hold by implementing an optimized rollout algorithm R*H^{h}. R*H^{h} keeps track of the current best solution found during the rollout algorithm.

REMARK 2. The solution quality of RH^{h} can be enhanced by supplementing the simple priority-rule based heuristic H^{h} with some local search or metaheuristic procedure, giving rise to the augmented rollout algorithm R K̅.

### The CP-ADP Algorithm

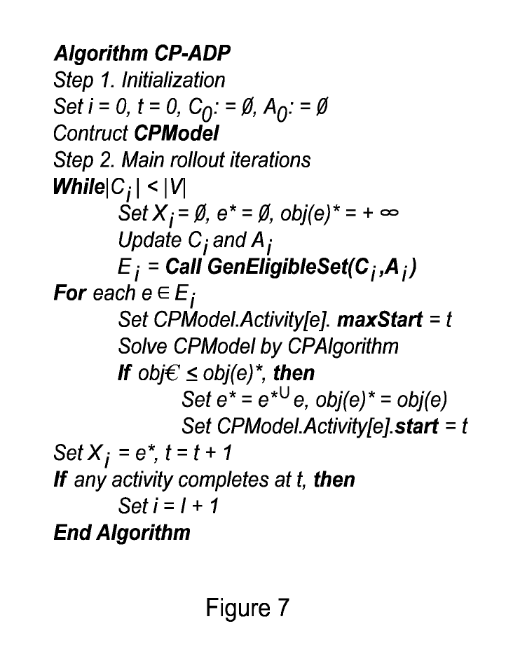

One example of the CP-ADP algorithm for RCPSP is described in FIG. 7. Step 1 initializes the stage counter i, time counter t, the set C of completed activities, set A of active activities and the CPModel for the deterministic RCPSP. Step 2 consists of the main rollout iterations. The procedure iteratively scans each time point while there is at least one activity that is not in the completed set, i.e. (|Cᵢ|<(|V|. In each iteration, the current set Eᵢ of eligible start activities is found by calling the subroutine GenEligibleSet, which takes the current Cᵢ and Aᵢ as parameters. Then for each element e in Eᵢ, the maximal starting time of the activity associated with e is fixed to be t. Solve the resulting CPModel by CPAlgorithm. Update the best set of starting activities e* and best makespan obj(e)* if necessary. The start times of the activities in e* is fixed at t, as if they have been scheduled to start at t. When no more eligible activities can be started without worsening the best makespan, the algorithm records the solution Xᵢ at stage i and increment the time counter t by 1. The stage counter i is incremented by 1 only when some activity completes at the new time point, according to our definition of stage.

### B. The CP-ADP Framework for SRCPSP

This section will describe an exemplary embodiment of the CP-ADP framework for the SRCPSP.

There are two distinct approaches in the prior work for obtaining policy-type solutions to the SRCPSP. The first approach attempts to find a sequence for all tasks at time 0, without waiting to see subsequent realization of task durations. The predetermined task sequence is statis in nature and not updated during real-time executions. Using the terminology in optimal control theory, it corresponds to an open-loop policy. The second approach aims at finding a dynamic or closed-loop policy, in which scheduling decisions are made in a sequential fashion through the methodology of dynamic programming. Instead of being interested in finding an optimal task sequence at one time, a closed-loop policy seeks to find optimal rule for selecting the task(s) to start at each decision-point, given the current state of the system. This makes it possible to take advantage of information that becomes available between decision-points. The closed-loop policy is adaptive in nature and more flexible than the open-loop policy.

Although being theoretically attractive, to obtain closed-loop policy has been generally perceived as being computationally intractable for the SRCPSP due to the well-known “curses-of-dimensionality” of the exact DP method. The present invention resolves this problem by designing a rollout algorithm to schedule tasks sequentially in conjunction with project execution. Especially, this embodiment of the CP-ADP framework offers a computationally tractable algorithm for generating near-optimal closed-loop policy for the SRCPSP.

### Problem Setting

The problem setting of SRCPSP is described first, followed by its MDP formulation, which lays foundation for the rollout algorithms to be developed in this section.

Consider an activity-on-node (AON) project network described by G (V, E), where V={0,1, . . . , n, n+1} denotes a set of activities in the project. Activity 0 and n+1 are the dummy start and end of the project, respectively. E represents a set of precedence relationships among activities, i.e. for (i,j)εE it is required that j cannot start before i is finished. A set K=(1, 2, . . . , m} of resources are needed for the project to execute. Each resource kεK has a limited capacity Rₖ≦R, whose availability is renewable every time period. An activity j requires rᵢₖ units of resource k during its execution. No preemption is allowed, i.e. an activity cannot be interrupted once started. Let denote \tilde{d}ⱼ the random duration of activity jεJ. It is assumed that \tilde{d}ⱼ follows certain probability distribution, discrete or continuous, which is known to decision-maker and stochastically independent. The goal of SRCPSP is to find a time- and resource-feasible solution, which minimizes the expected makespan.

### Markov Decision Process Formulation

The CP-ADP framework models the SRCPSP as a Markov decision process with the following components.

### Stages

A decision stage is defined as a time point when any task is completed. The number of stages is finite and bounded by |V|

### States

The state at stage i is define as Sᵢ=(Cᵢ, Aᵢ, Rᵢ, Dᵢ), where Cᵢ denotes the set of completed activities, Aᵢ is the set of active activities in progress, Rᵢ denotes the vector of available resource capacities, Dᵢ represents the vector of duration realizations at stage i.

If \tilde{d}ᵢ follows a discrete probability distribution of the form: pⱼ(d)=Prob{\tilde{d}ⱼ=d}, and letting r be the maximum number of possible realizations of \tilde{d}ᵢ, we have the following proposition concerning size of the state space.

PROPOSITION 2. Cardinality of the state space of the MDP model is:

0(n²R^{m}rⁿ) (12)

PROOF. The cardinality of both Cᵢ and Aᵢ is 0(n). The cardinality of Rᵢ is bounded by R^{m}. There are a total of rⁿ possible scenarios of duration realization. Thus the result holds.

### Decisions

The decision made at each stage is a set of activities to be started at that stage. Let the decision at stage i be xᵢεE(s), where E(s) is a set of activities that are eligible to be started for the current state s. E(s) defines the feasible region of xᵢ and can be described as follows:

{E(s)|∀eεEᵢ satisfies all precedence constraints and Σ>jεeuAᵢrⱼₖ≦Rₖᵢ}, (1)

where Rₖᵢ is the capacity of resource k available at stage i.

### Transition Process

The transition process of MDP can be described as follows:

Sᵢ₊₁=S^{M}(Sᵢ,xᵢ,wᵢ) (13)

The state Sᵢ₊₁ at stage i+1 depends only on the current state Sᵢ, decisions xᵢ, and random disturbance wᵢ at stage i, which is known as the Markov property. The transition function S^{M}(·) may in general represent a probability transition matrix as in the GERT context. That is, the random disturbance wᵢ may include both the non-structural randomness such as uncertain activity durations, and the GERT-type structural randomness such as uncertain task outcomes, task success/failure rates, etc. That is, wᵢ represents the set of random task duration \tilde{d}ⱼ of task j at stage i.

Let gᵢ(S, x, w) denote the one-stage cost function. When the objective is to minimize makespan as in the SRCPSP gᵢ(S,x,w) represents the increment of makespan at stage i. The goal is to choose the best policy π among the set of policies II, to minimize the expected total cost over a finite number of stages i={0,1, . . . , |V|). The cost-to-go function of it starting from a state-stage pair (Sᵢ, i) can be written as:

Jᵢ(Sᵢ)= [symbol] {Σⱼ₌ᵢ_{^{j}}^{|V|}gi(Si,xᵢ^{π}wᵢ)) (14)

The cost-to-go function can be calculated through the following backward recursion of Bellman:

Jᵢ(S)= [symbol] {g(S,xᵢ^{π},w)+Jᵢ₊₁(S^{M}(Sxᵢ^{π},w))} (15)

### The Priority-Based Rule Heuristic

Let g^{x} (Sᵢ,Sᵢ₊₁) denote the random cost (makespan) when the system is in state Sᵢ with decision xεE(Sᵢ) made, and then transits to Sᵢ₊₁ with certain randomness. Note that the disturbance term w has been implicitly included to simplify the notation. The rollout policy for SRCPSP can now be computed as:

x(Sᵢ)=arg min,_{xεE(S}_{ᵢ}₎ [symbol] {g^{x}(Sᵢ,Sᵢ₊₁)+H(Sᵢ₊₁)}, (16)

where H (Sᵢ₊₁) denotes the cost-to-go at state Sᵢ₊₁ following policy H.
DEFINITION 3. A rollout algorithm for a stochastic RCPSP is terminating if it is guaranteed to generate a complete and feasible sequence of activities starting from any activity.
LEMMA 2. A rollout algorithm RH^{h} for SRCPSP is terminating.
PROOF. Since the SRCPSP involves only the randomness of task durations, its underlying network is acyclic with a finite number of nodes. Thus a task is never repeated in a feasible sequence generated by the priority-rule heuristic H^{h}, and the length of a feasible sequence is always equal to the number of tasks in the project. Therefore, H^{h} for SRCPSP is terminating.
REMARK 3. Lemma 2 may not hold for a stochastic RCPSP with GERT-type of randomness, as a typical GERT network contains cycles.

Let L be the random number of stages in the rollout algorithm. Following the definition of stages, L is bounded by |V|. The following propositions are established for SRCPSP.

PROPOSITION 3. Let RH be a rollout policy with the base policy being a static priority-rule heuristic H. The following inequalities hold for i=1, . . . , L:

$$\begin{matrix}H ( {S}_{0} ) \geq 𝔼 \{ {g}^{RH} ( {S}_{0} , {S}_{1} ) + J ( {S}_{1} ) \} … \\ \geq 𝔼 \{ {g}^{RH} ( {S}_{0} , {S}_{i} ) + H ( {S}_{i} ) \} … \\ \geq 𝔼 \{ {g}^{RH} ( {S}_{0} , {S}_{L} ) \} .\end{matrix} \qquad ( 17 )$$

PROOF. Since H uses a static priority-rule, it is sequential consistent (Lemma 1). Then H(S₀)= [symbol] {g^{RH}(S₀,S₁)+H(S₁)≧min_{xεeE(S}_{₀}₎ [symbol] {g^{RH}(S₀,S₁)+H(S₁)} is calculated according to (10). Thus the proposition holds for i=1.

Use the method of induction. Assuming that it holds for i>1, i.e. H(S₀)≧ . . . ≧ [symbol] {g^{RH}(S₀,Sᵢ)+H(Sᵢ)}, it is needed to show that it also holds for i+1. Following (10) again, H(Sᵢ)≧ [symbol] {g^{RH} (Sᵢ,Sᵢ₊₁)+H (Sᵢ₊₁)}. Then the blow is calculated:

$$\begin{matrix}H ( {S}_{0} ) \geq … \\ \geq 𝔼 \{ {g}^{RH} ( {S}_{0} , {S}_{i} ) + 𝔼 \{ {g}^{RH} ( {S}_{i} , {S}_{i + 1} ) + H ( {S}_{i + 1} ) \} \} \\ = 𝔼 \{ {g}^{RH} ( {S}_{0} , {S}_{i + 1} ) + H ( {S}_{i + 1} ) \}\end{matrix} \qquad ( 18 )$$

Thus the proposition holds for i+1. Since the rollout policy RH is terminating Lemma 2), by induction H(S₀)≧ . . . ≧ [symbol] {g^{RH} (S₀, S_{L})+H (S_{L})} is calculated. Note that H(S_{L}) at the terminal states S_{L} is zero as it involves starting the dummy end activity. Therefore, the entire series of inequalities hold.

Skipping the intermediate terms in the series of inequalities of Proposition 3, H(S₀)≧ [symbol] {g^{RH} (S₀, S_{L})} is calculated, which establishes the following Corollary.

COROLLARY 3.1. The expected makespan of schedule generated by the rollout policy RH^{h} based on a static priority-rule heuristic H^{h} is no larger than that obtained by H^{k} alone.

### Enhancement of RH^{h}

It is well-known that the quality of priority-rule based heuristics are often highly unpredictable, which implies that the base policy offered by any priority heuristic alone may not be of high quality. Also, minimization in (10) implies that, in order to compute xᵢ (S) it is necessary to know the cost-to-go at all next possible states, which is not computationally tractable for the SRCPSP with a large number of scenarios. Instead of attempting to obtain the closed form cost-to-go, Monte Carlo simulation is used to approximate it. However, in order to obtain accurate estimation, a large number of samples need to be simulated, which can be computationally intensive.

Thus the rollout algorithm RH^{H} with priority heuristic H^{h} as base policy can be enhanced in the two ways. First, an augmented rollout algorithm RK (Remark 2) can be designed to improve the quality of the underlying base heuristic. Second, some approximation architecture can be employed to reduce the computational burden of pure Monte Carlo simulation.

1. R K̅ with Constraint Programming

An augmented rollout algorithm, called R H̅-CP, with CP serving as the base heuristic is devised to enhance R^{h}. In the integrated framework, CP is embedded in DP to model and solve the subproblem at each DP iteration.

The time-table and disjunctive constraint propagation can be employed to reduce the domain of task starting times whenever the domain of related tasks is modified. Let a. start and a. end denote the start and end of activity a, respectively. Let [ESₐ, LSₐ] be the time window of a, where ESₐ and LSₐ represent the earliest and latest start of activity a, respectively. The time-table constraint propagation repeatedly modifies [ESₐ, LSₐ] by maintaining the following inequality:

ΣaεV:a.start≦a.end^{r}ak≦Rₖ ∀t,k (19)

The disjunctive constraint propagation introduces new disjunctive relationships for any pair of activities (i, j) whose resource requirement of a resource k exceeds the available capacity Rₖ. That is, for any (i,j) and k such that rᵢₖ+rᵢₖ>Rₖ, the following disjunctive constraints are imposed:

i.end≦j.start or j.end<i.start (20)

(19) and (20) are shown to achieve satisfying domain reduction, for the need of base policy with reasonable computational efforts.

Since constraint propagation alone is often not able to reduce the domain of each decision variable to a singleton, search is needed in CP. Let Ω be the set of eligible activities whose start and end times have not been fixed. A depth-first search used in our implementation can be sketched as follows.

### Step 1. Initialization

### Set Ω:=V

Step 2. If all the activities' start and end times are fixed, obtain the current makespan and update the its upper bound if needed; otherwise, eliminate those whose start and end times have been fixed from Ω.
Step 3. If |Ω|≠0, then select an activity aεS (according to some pre-specified rules) and create a choice point for the selected activity (to allow standard backtracking). Schedule a to start from its time window [ESₐ, LSₐ]. Go to Step 2.
Step 4. If |Ω|=0, backtrack to the most recent choice point. If there is no such choice point, return the best solution found and terminate.
Step 5. Upon backtracking, eliminate the activity that was scheduled at the choice point from Ω. Go to Step 2.

Two activity selection rules can be considered at Step 3.

Rule-1: Among the eligible activities in S having the minimal earliest start times, it chooses one having the minimal earliest end time.
Rule-2: Among the eligible activities in S having the minimal earliest start times, it chooses one having the maximal earliest end time.
REMARK 4. The CP search embedded in the rollout framework needs not to be exhaustive, giving rise to a truncated CP search. The goal is to obtain a good heuristic solution fast, which is often one advantage of CP.
REMARK 5. A priority-rule based heuristic can be viewed as a truncated CP without constraint propagation or choice points (backtracking).

### 2. Limited Simulation

To reduce the burden of pure Monte Carlo simulation, a limited simulation can be implemented. This method generates m=1, 2, . . . , M scenarios, with M being significantly less than the number of samples needed in Monte Carlo simulation. Let the scenario at state sᵢ be represented as a sequence of realization of the task duration vector Diⁿ:

ω^{m}(sᵢ)=[Dᵢ^{m},Dᵢ_{⁺¹}^{m}, . . . , D_{L}_{^{−1}}^{m}] (21)

Then the cost-to-go of the base policy can be approximated as follows:

J̅ᵢ(sᵢ,r)=r₀+Σₘ_{⁼¹}^{M}rₘH^{m}(sᵢ), (22)

where H^{m}(s₁) is the makespan obtained by executing the base heuristic H under the scenario ω^{m} (sᵢ) starting from sᵢ, and the vector r=[r₀, r₁, . . . , rᵢd are the aggregate weights that encodes the aggregate effect of uncertain disturbances similar to the scenario ω^{m} (sᵢ) on the corresponding cost-to-go function (Bertsekas and Castanon 1999). In our implementation, we obtain r through an “offline” training procedure, where H^{m}(sᵢ) is treated as the features at state sᵢ using the linear feature-based architecture in (22).

C. Hybrid CP-ADP

This section will describe an alternative embodiment of the CP-ADP framework which adopts a look-back approach. The basic CP-ADP can be modified to combine with this look-back approach to further enhance its computation power. This is referred to herein as “ADP-HBA” (ADP with Hybrid Look-back/Look-ahead Approximation).

In this embodiment, the CP-ADP framework has two phases. In Phase 1, an offline training phase (e.g., test stage) is performed to generate a look-up table for look-back evaluation using MC simulation and CP. In this training phase, same MC simulation is used to generate N sample paths; however, the system 200 of FIG. 2 evaluates the cost-to-go function of every state-decision pair (S, x) visited through k=1, . . . , N sample paths:

$$\overline{J} ( S , x ) = \frac{{\sum }_{k = 1}^{N ( S , x )} {L}_{k} ( S , x )}{N ( S , x )} \qquad ( 23 )$$

As N(S, x) increases, J(S, x) converges to its true value. The system 200 stores the calculated mean values of all sample paths with the same sequence of activities in the database 204 (e.g., a look-up table).

In Phase 2, an online rollout procedure is performed to generate sample paths via MC simulation for forward iteration. This phase is identical to the other basic embodiments of the CP-ADP, except that the ADP-HBA calculates not every sample path generated by MC simulation but only those sample paths that are not generated in Phase 1. The system 200 retrieves the stored mean values from the database 204, instead of calculating the cost-to-go function of every sample path generated in Phase 2. This will enhance the computation power of the system. Therefore, the look-ahead rollout approach eliminates the needs to visit every (S, x). On the other hand, the look-back evaluation via lookup table significantly reduces the computational burden of a pure look-ahead rollout approach. This hybrid CP-ADP is expected to offer more effective and efficient solutions than either the look-back or look-ahead approach alone.

### D. Results

To verify the superior performance of the CP-ADP over other known prior art systems, three sets of computational experiments were conducted. Results on the deterministic problems provide insights about proper configuration of the rollout algorithm. The second experiment is conducted on randomly generated small instances for which their deterministic solutions can be obtained by CP, thus the expected value with perfect information (EV|PI) is known. The third is on large random instances which can only be heuristically solved.

### 1. Results on Deterministic Instances

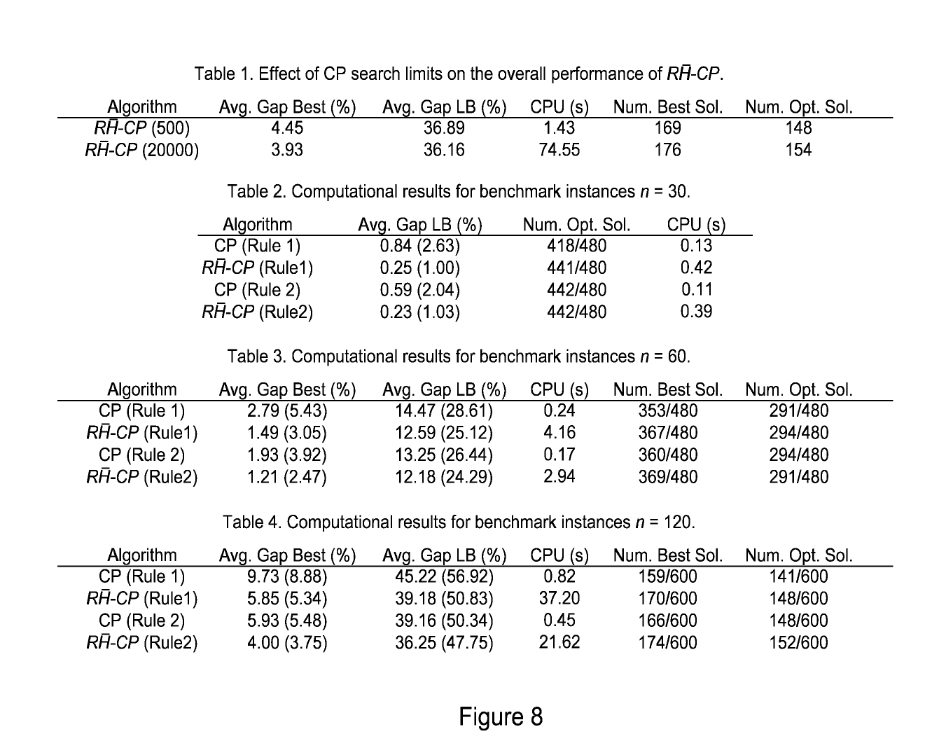

To examine the effect of computational effort of CP tree search on overall performance of the CP-ADP algorithm, two versions of the algorithms were compared by setting the maximum number of fails in the CP search to be 500 and 20000, respectively. The two versions of CP-ADP were run on the 120-task PSPLIB instances. FIG. 8 shows the results on deterministic instances. Table 1 reports the average gap between the best-known solution (Column 2), average gap between the CPM lower bound (Column 3), average CPU for finding best solutions (Column 4), number of best solutions found (Column 5) and number of optimal solutions found (Column 6). R H̅-CP in Table 1 refers to the CP-ADP algorithm.

As shown in Table 1, while a more intensive CP search (with a 20000 fail limit) obtains better quality solutions, it also takes significantly more computational time. A less intensive or truncated CP search (with a 500 fail limit) is able to achieve competitive solution quality using much less time.

Results in Table 1 have demonstrated some desirable characteristics of the R H̅-CP algorithm: (1) The intensity of CP search efforts can be controlled by setting some search limits to tradeoff between solution quality and computational time and (2) The overall performance of R H̅-CP appears to be quite robust to the CP search limits. In the subsequent computation experiments, a medium CP search effort of 5000 fail limit is used.

Table 2 shows the results for the 480 30-task PSPLIB instances, for which all optimal solutions are known. The average gap from optimal solutions and the standard deviation in parenthesis (Column 2), the number of optimal solutions found (Column 3) and average CPU for finding best solutions (Column 4) are reported in Table 2. Rule-2 performs better than Rule-1. The R H̅-CP algorithm outperforms its underlying pure CP methods (with the same configuration), although spending more time reaching best solutions. The better configured R H̅-CP algorithm with Rule-2 obtains solutions with 0.23% gap in less than a second on average.

Table 3 shows the results for the 480 60-task instances, for which not all optimal solutions are known. R H̅-CP consistently improves over the pure CP, and Rule-2 again performs better. The best configured R H̅-CP with Rule-2 obtains solutions with 1.21% gap between the best-known solutions in about 3 seconds on average.

Table 4 shows the results for the 600 120-task instances. The best configured R H̅-CP is able to find solutions within 4% gap between the best-known solutions using a reasonable computational time.

### 2. Results on Small Stochastic Instances

Stochastic instances are generated in the following way. The size of project scheduling network is determined by the number of tasks N, which varies in the set {6, 10, 14}. For problems of such size, their deterministic version can be optimally solved by CP to obtain the EV|PI, which is then used as a benchmark to evaluate solution quality of rollout algorithms. When RT=0 the network is parallel; when RT=1 the network is serial. In the experiment, RT takes values from {0.1, 0.5, 0.9}. The resource factor (RF) and resource strength (RS) can vary. The RF controls the intensity of resource requirement, i.e., a low RF indicates that fewer types of resources required by a task on average. The RS controls the availability of resource capacity, i.e., a high RS indicates that more resource capacity is available on average. For each task, it was assumed that the duration follows a discrete probability distribution with a maximum of two realizations. A total of 81 small instances are generated.

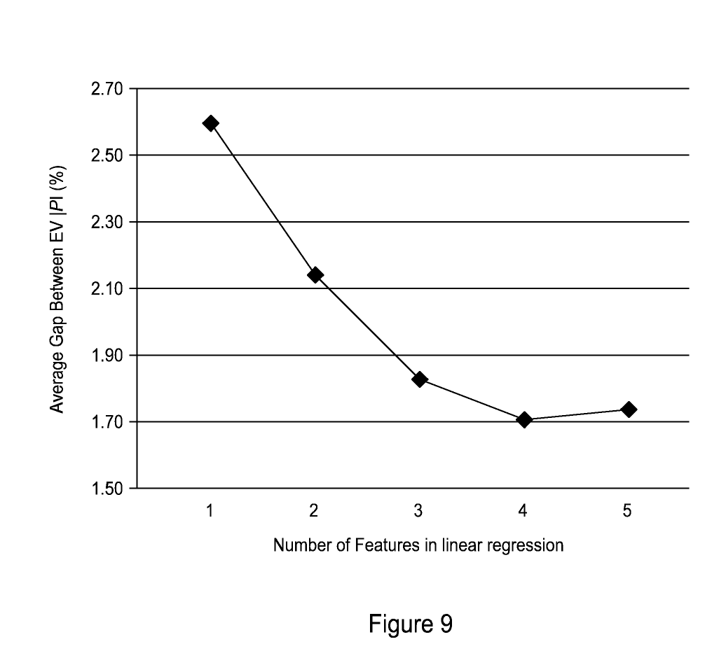

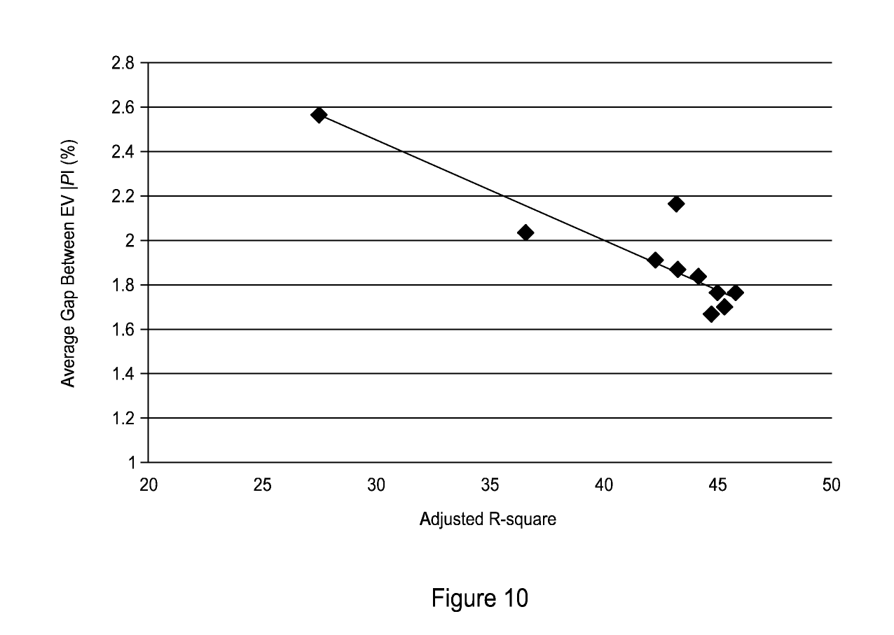

First, the impact of different configurations of limited simulation on solution quality was examined. FIG. 9 shows that the average optimality gap decreases as the number of features in the linear architecture increases. This is probably due to the more accurate estimate or higher goodness-of-fit achieved by including more independent variables in the regression equation. FIG. 10 supports this claim, where the quality gap appears to follow a (linear) decreasing relationship with respect to the adjusted R-square.

The shape of curve in FIG. 9 tends to be flatter, suggesting that the benefit of having more features might have a diminishing return-of-scale. In addition, more computational effort will be needed when more features are used. Thus one needs to balance the solution quality and computational effort of algorithm by limiting the number of features. In the following experiments, the number of features was fixed to be four (4).

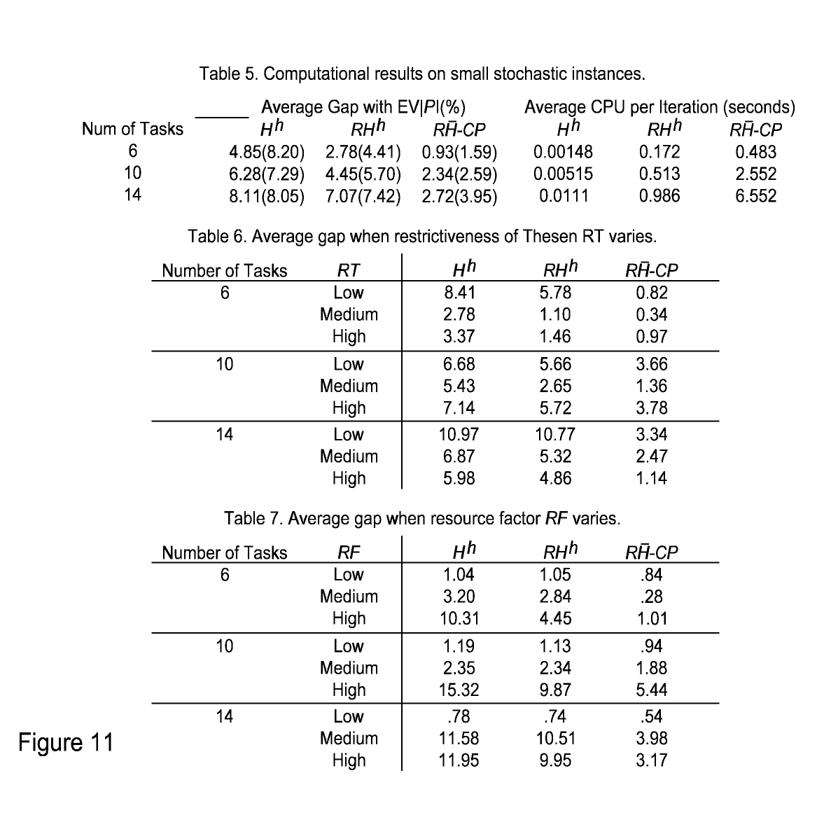

For each stochastic instance, three algorithms are executed: a simple heuristic H^{h} with the shortest processing time (SPT) priority rule, a basic rollout algorithm RH^{h} with H^{h} as the base policy, and an augmented rollout algorithm R H̅-CP with CP and limited simulation (i.e., the CP-ADP algorithm). FIG. 11 shows the results. In Table 5 of FIG. 11, the numbers in parenthesis are standard deviations. RH^{h} consistently improves its underlying priority-rule base heuristic H^{h}. The augmented R H̅-CP further consistently outperforms RH^{h}. Notably, it obtains policies with less than 2% gap from EV|PI on average.

Further analysis of solution quality with respect to problem parameters: RT, RF, and RS are provided by Table 6 through Table 8. As shown in Table 6, less restrictive networks (i.e., those closer to a parallel structure) are expected to be more challenging to solve as more feasible sequences need to be evaluated. Networks with medium restrictiveness appear to be easier to solve. More restrictive networks (i.e., those closer to a serial structure) can also be challenging, except for large size networks where higher restrictiveness can result in significantly fewer number of feasible sequences. For instance, problems with 14 tasks and more restrictive structure appear to have lower average gap. Table 6 also shows that priority-rule based methods perform relatively well when the network is more restrictive, where the number of feasible sequences is limited; when the network is less restrictive, their solution quality is expected to be worse as they fail to explore a large number of alternative feasible (and potentially high quality) sequences. For instance, for problems with 14 tasks and less restrictive structure, H^{h} alone has an average gap of 10.97%, RH^{h} is not able to improve much with average gap of 10.77%. Notably, with CP serving as the base policy, R H̅-CP is able to achieve an average gap of 3.34%.

It is expected that when resource requirements become more intensive, i.e., when resource factor RF is larger, problems can be more challenging to solve. Results in Table 7 support this claim. Furthermore, it was observed that solution quality of priority-based it alone is satisfying when resource requirement is less intensive. When resource requirement is more intensive, the quality of H^{h} and RH^{h} decreases quickly, although RH^{h} improves over it moderately. Notably, R H̅-CP is able to obtain significantly better solutions when RF is high. In all, the benefit of replacing H^{h} with CP in the rollout framework appears to be more significant when resource requirement is more intensive.

The effect of availability of resource capacity, measured by resource strength RS, can be more subtle. When the resource capacity is tight, i.e., when RS is low, the number of feasible sequences might be limited. Increasing resource capacity will potentially increase the number of feasible sequences, which makes the problem more challenging (with higher optimality gap). When the resource capacity is ample, however, the issue of sequencing becomes less critical as many alternative sequences may result in the same solution quality (plenty of resource available). Thus it is expected that problems with medium availability of resources is more challenging to solve, which is corroborated by the results in Table 8 of 3. In each case, R H̅-CP appears to consistently improve over its counterparts of H^{h} and RH^{h}.

### 3. Results on Large Stochastic Instances

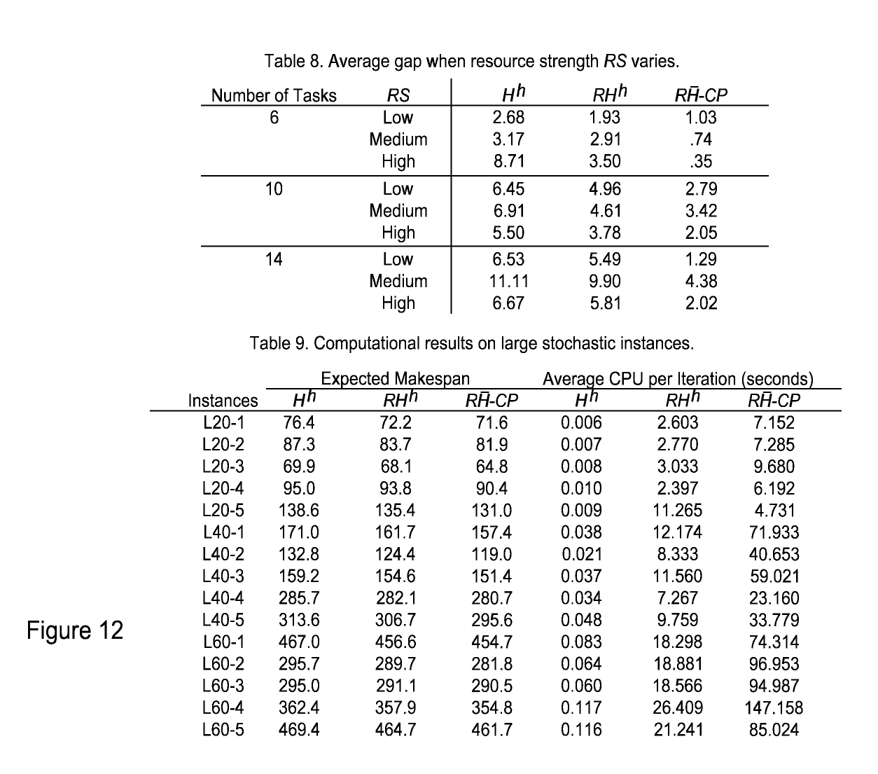

To test the performance of algorithms on large problems, fifteen instances of size 20, 40, and 60 are generated. As the EV|PI is not available for these instances, the mean of makespan and computational time of each algorithm in Table 9 of FIG. 12 is directly reported. RH^{h} improves over its underlying H^{h} by 2.78% on average. R H̅-CP further improves over RH^{h} by an average of 2.18%, and over H^{h} by about 5% on average, with reasonable computational time.

### 4. Results of The ADP-HBA Performance

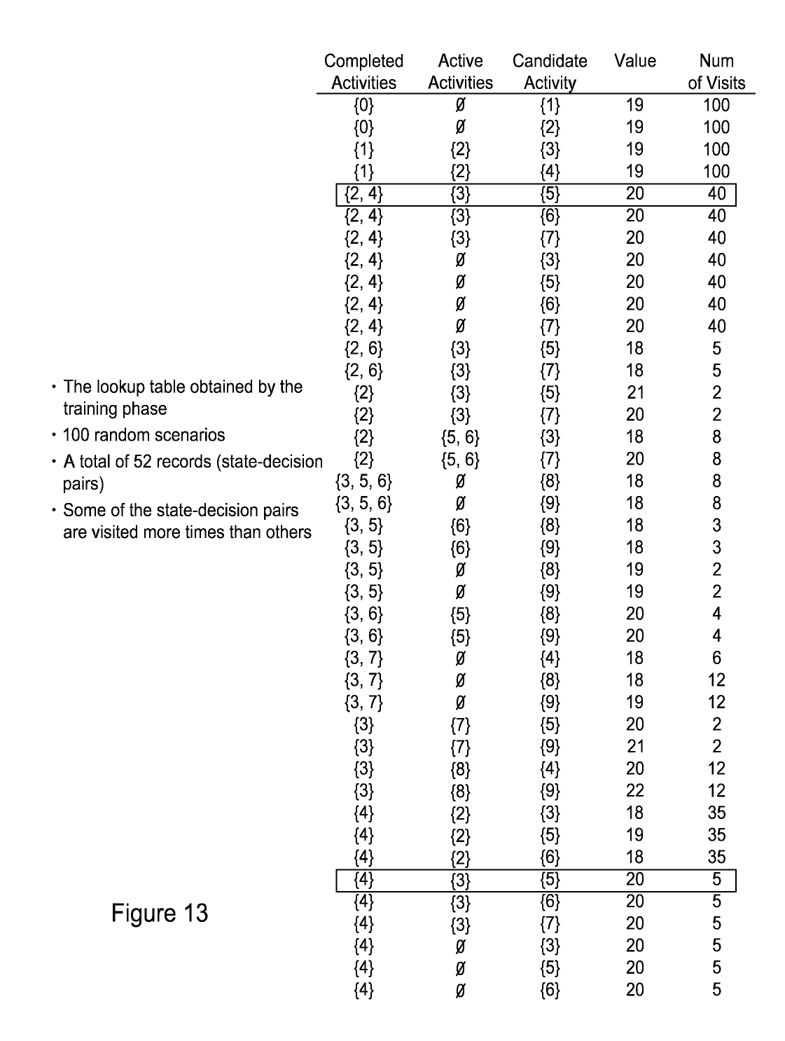

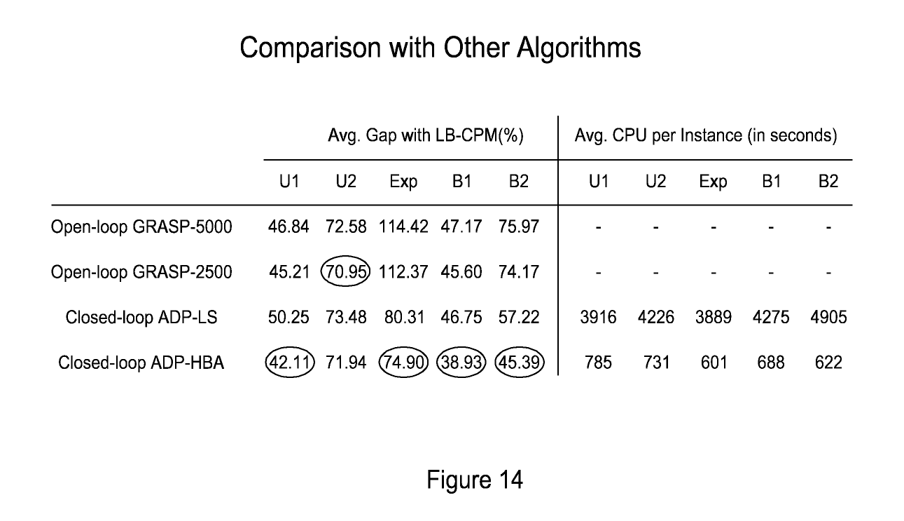

To test the performance of the ADP-HBA algorithm, 100 random scenarios were generated at a training phase. FIG. 13, shows a lookup table obtained by the training phase. A total of 52 records (state-decision pairs) are reported. FIG. 14, shows the results of the ADP-HBA's performance. As shown in FIG. 14, the quality of the ADP-HBA is competitive for the symmetric probability distribution case, and significantly outperforms the open-loop solution for the non-symmetric case, due to its dynamic and adaptive nature. The more look-ahead rollout evaluations, the more time for the ADP-HDP to solve an instance, and conversely, the use of look-up table significantly reduces the solving time of the ADP-HBA.

The present invention develops computationally tractable algorithms to obtain near-optimal closed-loop policy for the well-known challenging problem of scheduling projects with both resource constraints and stochastic task durations. Utilizing the idea of approximate dynamic programming in the rollout framework, the CP-ADP algorithm sequentially improves over a base policy offered by any heuristic method existing in the literature. The basic rollout algorithm is further enhanced by embedding constraint programming as the base heuristic, and using limited simulation to effectively reduce the number of scenarios to be simulated. Computational results show that with reasonable computational effort, the CP-ADP algorithm is capable of providing high quality solutions to this category of scheduling problems.

It should also be understood that when introducing elements of the present invention in the claims or in the above description of the preferred embodiment of the invention, the terms “comprising”, “applying”, and “using,” are intended to be open-ended and mean that there may be additional elements other than the listed elements. Moreover, use of identifiers such as first, second, and third should not be construed in a manner imposing time sequence between limitations unless such a time sequence is necessary to perform such limitations. Still further, the order in which the steps of any method claim that follows are presented should not be construed in a manner limiting the order in which such steps must be performed unless such order is necessary to perform such steps.

1. A system for optimally scheduling a plurality of activities, said system comprising:
a memory configured to store data, wherein said data represents a plurality of activities and said plurality of activities are uncompleted, uncertain activities;
an input device for providing said data into said memory;
a processor configured to find a subset of said plurality of uncompleted, uncertain activities, as a first stage, that are eligible to be started at said first stage, wherein said eligibility is determined based on one or more eligibility requirements, then generate, for each of said eligible activities found, all feasible sequences of activities that can be executed in a predetermined order following said each of said eligible activity, wherein said feasible sequences of activities satisfy said eligibility requirements and a set of pre-defined constraints, then calculate, for each of said generated feasible sequences, a cost-to-go function, wherein said processor calculates an expected total cost for executing said activities in each of said generated feasible sequences, then select an optimal activity among said eligible activities, wherein said optimal activity is an activity which generates said sequence of activities with said lowest cost-to-go-function, then assign said optimal activity as a completed-activity when said optimal activity is completed, wherein said completion of said optimal activity triggers a second stage, wherein said second stage involves repeating said first stage, with said processor, until all said activities in said plurality of activities are assigned as said completed activity; and
an electronic display for viewing said scheduling of activities, wherein said memory, said input device and said electronic display are all electrically connected to said processor.

2. The system for optimally scheduling a plurality of activities according to claim 1, wherein said processor is adapted to generate said feasible sequences of activities, wherein said processor executes a code embodying constraint programming stored in said memory to generate only those sequences that satisfy said pre-defined constraints.

3. The system for optimally scheduling a plurality of activities according to claim 2, wherein said processor utilizes a time-table and disjunctive constraint propagation to provide constraint programming.

4. The system for optimally scheduling a plurality of activities according to claim 2, wherein said processor operates with a backtracking method that eliminates said activities that do not satisfy said pre-defined constraints in constraint programming.

5. The system for optimally scheduling a plurality of activities according to claim 1, wherein said eligibility requirements comprise one or any combination of precedence relationships among activities, resource requirement of activities, available resource capacities, and duration of activities.

6. The system for optimally scheduling a plurality of activities according to claim 1, wherein said pre-defined constraints comprise a predetermined set of static priority rules.

7. The system for optimally scheduling a plurality of activities according to claim 1, wherein said pre-defined constraints comprise a predetermined set of dynamic priority rules.

8. The system for optimally scheduling a plurality of activities according to claim 2, wherein said processor randomly generates N samples of said feasible sequences of activities and said constraint programming further eliminates any sequence among said N samples that does not satisfy said pre-defined constraints.

9. The system for optimally scheduling a plurality of activities according to claim 8, wherein said processor utilizes Monte Carlo simulation to randomly generate said N samples by executing a code embodying said method of Monte Carlo simulation stored in said memory to generate said N samples.

10. A system for optimally scheduling a plurality of activities, said system comprising:
a memory configured to store data, wherein said data represents a plurality of activities and said activities are uncompleted, uncertain activities;
an input device for providing said data into said memory;
a processor configured to find a subset of said uncompleted, uncertain activities, as a test stage, that are eligible to be started at a first stage, wherein said eligibility is determined based on one or more eligibility requirements, then generate, for each of said eligible activities found, N samples of feasible sequences of activities that can be executed in a certain order for each of said eligible activity, wherein said feasible sequences of activities satisfy said eligibility requirements and a set of pre-defined constraints, then calculate a mean value of cost-to-go functions of any of these same said feasible sequences of activities that are randomly generated, wherein said cost-to-go function is an expected total cost for executing said activities in said generated feasible sequence, then store said mean value in said memory during said test stage, then, at a first stage, find a subset of said uncompleted, uncertain activities that are eligible to be started at said first stage, wherein said eligibility is determined based on one or more of eligibility requirements, then generate, for each of said eligible activities found, N samples of feasible sequences of activities that can be executed in a certain order following each of said eligible activity, wherein said feasible sequences of activities satisfy said eligibility requirements and said set of pre-defined constraints, then calculate a cost-to-go function of only those feasible sequences of activities whose mean values are not calculated during said test stage, then said processor retrieves from said memory said stored mean value of said feasible sequence generated during said test stage and utilizes said retrieved mean value as a cost-to-go function of any feasible sequence generated during said first stage that is identical to said feasible sequence generated during said test stage, said processor then selects an optimal activity among said eligible activities, wherein said optimal activity is an activity which generates said sequence of activities with said lowest cost-to-go-function, said processor then assigns said optimal activity as a completed-activity when said optimal activity is completed, wherein said completion of said optimal activity triggers a second stage, wherein at said second stage, repeat said first stage, wherein said processor repeats said first stage until all said activities in said pool are assigned as a completed-activity; and
an electronic display for viewing and scheduling of all activities, wherein said memory, said input device and said electronic display are all electrically connected to said processor.

11. The system for optimally scheduling a plurality of activities according to claim 10, wherein said processor executes a code embodying said method of constraint programming stored in said memory to generate only those sequences that satisfy said pre-defined constraints, wherein said constraint programming is adopted to generate said feasible sequences of activities.

12. The system for optimally scheduling a plurality of activities according to claim 10, wherein said processor utilizes Monte Carlo simulation to randomly generate said N samples by executing a code embodying said method of Monte Carlo simulation stored in said memory to generate said N samples.

13. A system for optimally scheduling a plurality of activities, said system comprising:
a memory configured to store data, wherein said data represents a pool of activities said activities are uncompleted, uncertain activities;
a processor configured to find a subset of said uncompleted, uncertain activities, as a first stage, that are eligible to be started at said first stage, wherein said eligibility is determined based on one or more of eligibility requirements, then generate, for each of said eligible activities found, all feasible sequences of activities that can be executed in a predetermined order following said each of said eligible activity, wherein said feasible sequences of activities satisfy said eligibility requirements and a set of pre-defined constraints, then calculate, for each of said generated feasible sequences, a cost-to-go function, wherein said processor calculates an expected total cost for executing said activities in each of said generated feasible sequences, then select an optimal activity among said eligible activities, wherein said optimal activity is an activity which generates said sequence of activities with said lowest cost-to-go-function, then assign said optimal activity as a completed-activity when said optimal activity is completed, wherein said completion of said optimal activity triggers a second stage, wherein said second stage involves repeating said first stage, with said processor, until all said activities in said pool are assigned as a completed-activity; and
a user interface unit configured to provide a user said optimal sequence of activities, wherein said user can retrieve data representing said optimal sequence of activities from said memory and for inputting data into said memory.

14. The system for optimally scheduling a plurality of activities according to claim 13, wherein said user interface unit further provides a graphic user interface (GUI) and said optimal sequence of activities is represented visually in an electronic display.

15. The system for optimally scheduling a plurality of activities according to claim 14, wherein said at least one of said eligibility requirements of activities and at least one of said pre-defined constraints of activities and provided via said graphic user interface (GUI) utilizing at least one input device.

16. The system for optimally scheduling a plurality of activities according to claim 13, wherein said processor eliminates potential sequences of activities that do not satisfy said pre-defined constraints.

17. The system for optimally scheduling a plurality of activities according to claim 16, wherein said processor utilizes Monte Carlo simulation to randomly generate said N samples by executing a code embodying said method of Monte Carlo simulation stored in said memory to generate said N samples.

18. A method for optimally scheduling a plurality of activities, said method comprising:
storing data provided by an input/ouput device representing a pool of activities in a memory, wherein said activities are uncompleted, uncertain activities;
finding a subset of said uncompleted, uncertain activities that are eligible to be started at a first stage, wherein said eligibility is determined based on one or more of eligibility requirements with a processor from said memory;
generating, with said processor, for each of said eligible activities found, all feasible sequences of activities that can be executed in a certain order following said each of said eligible activity, wherein said feasible sequences of activities satisfy said eligibility requirements and a set of pre-defined constraints, wherein each of said generated feasible sequences is stored in said memory;
calculating, with said processor, for each of said feasible sequences of activities generated, a cost-to-go-function which represents an expected total cost for executing said activities in each of said generated sequences, wherein each of said calculated cost-to-go-function is stored in said memory;
selecting an optimal activity among said eligible activities, with said processor, wherein said optimal activity is an activity which generates said sequence of activities with said lowest cost-to-go function;
assigning said optimal activity as a completed-activity when said optimal activity is completed, wherein said completion of said optimal activity triggers a second stage with said processor; and
repeating, at said second stage, said steps of said first stage, wherein said processor repeats said first stage until all said activities in said pool are assigned as a completed activity and providing all said completed activities on said input/output device.

19. The method for optimally scheduling a plurality of activities according to claim 18, wherein said generating step is performed by said processor which executes a code embodying said method of constraint programming stored in said memory to generate only those sequences that satisfy said pre-defined constraints.

20. The method for optimally scheduling a plurality of activities according to claim 18, wherein said eligibility requirements comprise one or any combination of precedence relationships among activities, resource requirement of activities, available resource capacities, and duration of activities.

21. The method for optimally scheduling a plurality of activities according to claim 19, wherein said generating step further randomly generates N samples of said feasible sequences of activities, wherein said method of constraint programming eliminates any sequence among said N samples that does not satisfy said pre-defined constraints.

22. The method for optimally scheduling a plurality of activities according to claim 21, wherein said processor executes a code embodying a method of Monte Carlo simulation stored in said memory to randomly generate said N samples.
